(19) United States
(12) Patent Application Publication
(10) Pub. No.: US 2004/0253957 A1
(43) Pub. Date: Dec. 16, 2004

(54) Mobile terminal control of the establishment of multimedia sessions

(76) Inventors: Mariana Benitez Pelaez, Naperville, IL (US); Karla Rae Hunter, Naperville, IL (US); Ronald Bruce Martin, Carol Stream, IL (US); Charu Verma, Darien, IL (US); Kamal K. Verma, Darien, IL (US)

Correspondence Address: Werner Ulrich, 434 Maple Street, Glen Ellyn, IL, 60137, US

(21) Appl. No.: 10/461,072

(22) Filed: Jun. 13, 2003

(51) Int. Cl. H04Q 7/20

(52) U.S. Cl. 455/445; 455/422.1; 455/414.1

(57) ABSTRACT

This invention relates to methods and apparatus for allowing an end user terminal in a multimedia network to provide various options for handling a session request including accepting the request, redirecting the session, releasing the session based on user input or predefined attributes stored in the originating device and/or the terminating device.

### TECHNICAL FIELD

This invention relates to methods and apparatus for allowing an end user device in a multimedia network to have various options for handling a session request based on user input or predefined session attributes stored in the device.

### BACKGROUND OF THE INVENTION

The telecommunications network is becoming ever more flexible having the ability to transport ordinary voice, low speed packet data, high speed packet data, video, instant messaging and file transfers. Currently, the end user device has limited control in real time over the treatment of a session. This problem is exponentially exacerbated with the advent of the multimedia network and is multiplied by the emerging diversity of the end user devices' ability to handle these new media types.

### SUMMARY OF THE INVENTION

Applicants have carefully studied prior art arrangements and have concluded that what is needed is a method and apparatus for providing real time end user control, enhanced with flexible network controls that are responsive to such user control.

In accordance with one aspect of the present invention, a method of real-time treatment of sessions initiated by one end user device and controlled by a second end user device is provided. The method includes receiving a session setup signal from the calling party (the first end user device), examining the calling party's media attributes and end user defined policies, then taking an action based on either user intervention or on a predefined set of attributes/policies contained within the second end user device with no user intervention. Examples of end user defined policies include the following:

Redirect all file transfers request greater than X MB to IP address

122.23.33.255;

Drop all calls that restrict the calling line identification;

Redirect all voice calls to an external device; (such a device may contain a speech to text capability for graphically displaying voice messages);

Send a text message to the calling party before dropping the call; the end user may define a real time or predefined customization of the text message.

The present invention is to provide the end user the flexibility to handle the call in multiple ways. One advantage is that end users can advertise only one number, the number of the second end user device, for all types of sessions. Further advantages and benefits of the present invention will become apparent upon reading and understanding the present specification.

### BRIEF DESCRIPTION OF THE DRAWING(S)

FIG. 1 is a block diagram illustrating the session control network; and

FIG. 2 is a flow diagram of the invention scenario for a successful attempt.

### DETAILED DESCRIPTION

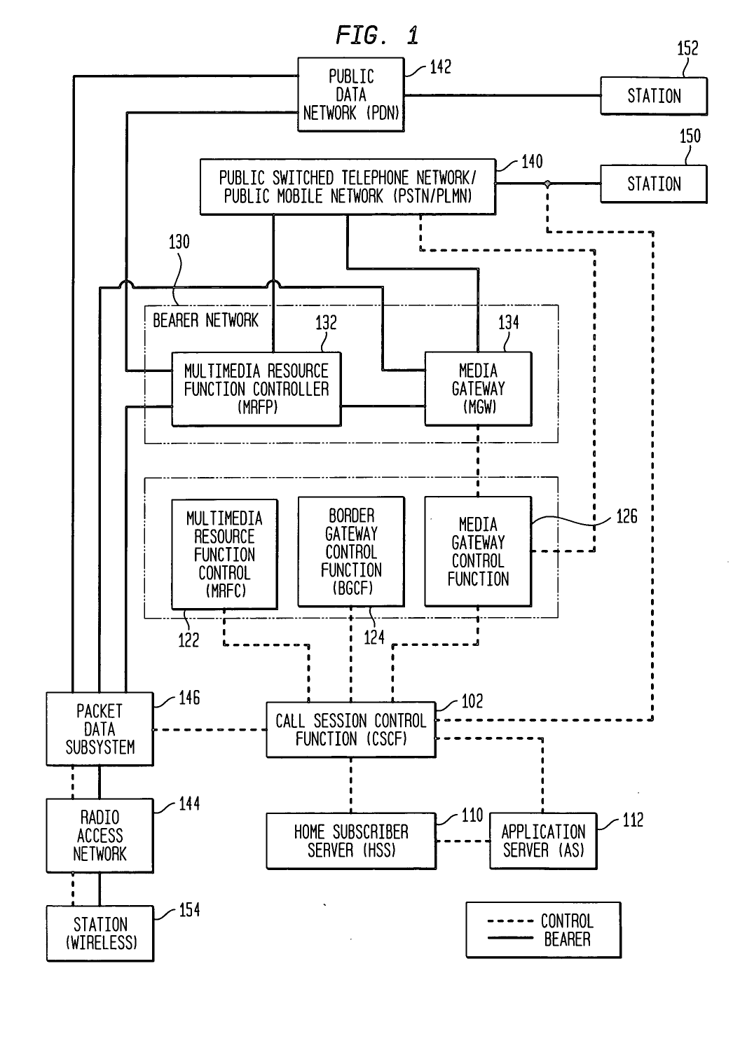

FIG. 1 is a block diagram illustrating the apparatus of Applicants' invention. Shown is an Internet protocol multimedia system (IMS) which is a call/session control network as well as a bearer network. In addition, the IMS can handle the advance services that a 2G (second generation) circuit switch network cannot handle; the IMS terminal 154 of FIG. 1 is a terminal that can handle a 3G (3rd generation) radio access interface and that can handle or process advanced applications such as multimedia.

Also shown is a telephone, i.e., a POTS (plain old telephone service) terminal 150 connected to the public switched telephone network (PSTN)/public mobile network (PLMN) 140. Also shown is a data terminal 152 connected to the public data network 142. The Internet is an example of a public data network. Sessions may be redirected to terminals such as terminal 150 and 152.

The main call controller elements are: Call Session Control Function (CSCF), Media Gateway control function (MGCF), Media Resource Function Controller (MRFC), Border Gateway Control Function (BGCF). The call session control function supports and controls the multimedia sessions. The CSCF provides the following functionalities. The CSCF acts as an entry point and routes incoming calls. The CSCF also performs the call control function, i.e., it controls call setup/termination and performs state/event management. State/event management allows the CSCF to maintain a record of the present state of a call (e.g., paging, cut through, etc. The CSCF also interacts to receive user profile information with a home subscriber server (HSS) 110 which maintains subscriber related data and with application server (AS) 112 which contains information for controlling customized applications.

The CSCF 102 also processes addresses by analyzing them, translating them where necessary, modifying and mapping these addresses. For example, if the CSCF recognizes that the call is directed to the PSTN it sends the setup request to the Media Gateway Control Function (MGCF) 126 to route the call through the PSTN and provide the appropriate SS7 (Signaling System 7) signaling messages to the PSTN. The multimedia resource function controller (MRFC) 122 controls the media stream resources in the multimedia resource function processor (MRFP) 132 whose use will be described below. In addition, the MRFC interprets information coming from the CSCF in order to control the MRFP.

The border gateway control function (BGCF) 124 receives control information from the CSCF and uses this information to select among one of a plurality of media gateway control function (MGCF) units 126.

The MGCF 126 controls the call state for media channels on one or more media gateways (MGW) 134, communicates with the CSCF, and performs conversion between legacy (pre-3G) protocols and third generation 3G UMTS/CDMA network call control protocols. For example, the MGCF can accept signaling from earlier systems such as ISUP signaling messages over circuit based connections and convert those ISUP messages into something that the CSCF can accept such as SIP (session initiation protocol) messages over a packet interface.

As noted above, the two units of bearer network 130 are the multimedia resource function processor (MRFP) 132 and the media gateway (MGW) 134. The MGW interfaces and inter-works with PSTN/PLMN networks. It receives signals from the packet data subsystem 146 which receives bearer data from the wireless user 154 and transmits such data to the PSTN/PLMN for distribution to PSTN/PLMN user 150. As an example, consider that the packet data subsystem 146 can propagate signaling information and bearer information to the intended destination which is another IMS user. This IMS user then, based on call attributes, can command the network to redirect the request for connection to terminal 150. When communicating with the public data network 142 or the public switched telephone network 140, the MRFP 132 performs functions such as multimedia conferencing. The MRFP performs multimedia conferencing, digit collection, interactive announcements and tone generation. This overall arrangement allows processors which have access both to the signaling data generated by users and the public networks to flexibly route bearer signals through the public telecommunication networks and to respond to user requests for establishing and changing multimedia connections.

The CSCF, HSS, MRFC, BGCF, MGCF, MRFP and MGW are all defined in the third generation partnership (3GPP) standards.

With the arrangement described above calls are now sessions and the call control functions are logically and physically separated from the connection control functions.

The purpose of an application server 112 is to allow a third party developers to build customized application bundles quickly and to allow these application bundles to be integrated into the IP multimedia system (IMS).

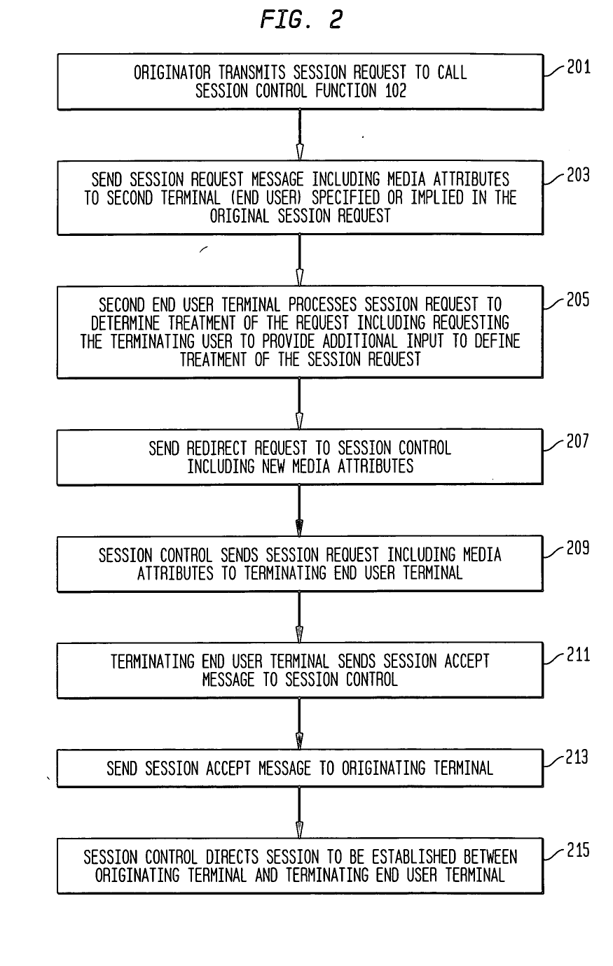

FIG. 2 is a flow diagram illustrating the operation of Applicants' invention. This example features a request which is initiated by a first user terminal such as terminal 152 and directed by that user terminal to another user terminal such as terminal 154. The originator of the communication session in this example is the user terminal 152. An originating terminal such as the terminal 152 transmits a session request to the call session control function. The second terminal (terminal 154) processes an incoming request and determines how the session should be handled based on user input or predefined policies. In this example, the call is redirected to another terminating device.

The CSCF interprets the session request message sent by the originator and transmits a session request including the requested media attributes to another user terminal (e.g., terminal 154).

Note that according to this scenario, a session request can be flexibly generated and can be flexibly responded to. If the original requested terminating terminal end user (i.e., the second user terminal) does not wish to participate in the session or is otherwise unable to do so, the second end user can redirect the session. The same general type of call flow can be used for establishing multi-port connections, such as conference or broadcast connections, and can be used to specify the type of medium and bandwidth of that type to be used in the connection.

The second user terminal processes the incoming session request (action block 205). This terminal can request that the session be established between the originating and second terminals or may have stored information indicating that this type of request should be passed to a different terminating end user terminal such as terminal 150 or that in response to this type of request an input from the user of the terminating end user terminal (e.g., terminal 150) is required. In this particular example, input from the user leads to a request (action block 207) to redirect the call to a different terminating end user terminal. The session control receives this redirect request and generates a new session request including the appropriate attributes to the new terminating end user terminal (action block 209). The new terminating end user terminal accepts the session request and sends a session accept message to the session control (action block 211). The session control can (optionally) inform the terminating terminal of the successful redirection of the session. The session control then sends a session accept message to the originating terminal (action block 213). The session control then causes the session connection to be established (action block 215).

The invention is particularly useful when applied to mobile terminals, but can also be used for connections and session involving only land based terminals. For land based terminals, the PSTN accesses the gateway and the media gateway control function in order to access the call session control function. The call control function can also be accessed by a packet data network in case the landline based terminal is a laptop. Subsequently, the processing of calls and sessions is essentially as described above.

The above description is of one preferred embodiment of Applicants' invention. Other embodiments will be apparent to those of ordinary skill in the art without departing from the scope of the invention. The invention is limited only by the attached claims.

We claim:

1. In a multimedia telecommunications network, a method of establishing a telecommunications session comprising the steps of:
sending a first session request message from an originating terminal to a call session control, said session request message comprising data for identifying a second terminal and treatment and/or media attributes of the telecommunications session;
transmitting a second session request message comprising data of said session request message to said second telecommunications terminal;
said second terminal transmitting a response message to said call session control for establishing a telecommunications session having said treatment and/or media attributes with a terminating terminal selected by data of said response message;
said call session control establishing a call session in conformance with data of said response message.

2. The method of claim 1 wherein said treatment and/or media attributes are stored in a database accessible by an end user device.

3. The method of claim 1 wherein said second terminal is not a participant in said telecommunications session.

4. The method of claim 1 wherein the step of establishing a call session comprises the step of establishing a call session involving more than two terminals.

5. The method of claim 1 wherein said response message is a redirect message.

6. The method of claim 1 wherein said response message requests a multimedia session.

7. The method of claim 1 wherein said originating terminal is a wireless station.

8. The method of claim 1 wherein said originating terminal is a multimedia device.

9. The method of claim 1 wherein said originating terminal is a mobile computer.

10. In a multimedia telecommunications network, apparatus for establishing a telecommunications session comprising:
means for sending a first session request message from an originating terminal to a call session control, said session request message comprising data for identifying a second terminal and treatment and/or media attributes of the telecommunications session;
means for transmitting a second session request message comprising data of said session request message to said second telecommunications terminal;
means for transmitting a response message from said second terminal to said call session control for establishing a telecommunications session having said treatment and/or media attributes with a terminating terminal selected by data of said response message;
in said call session control, means for establishing a call session in conformance with data of said response message.

11. The apparatus of claim 10 wherein said treatment and/or media attributes are stored in a database accessible by an end user device.

12. The apparatus of claim 10 wherein said second terminal is not a participant in said telecommunications session.

13. The apparatus of claim 10 wherein the means for establishing a call session comprises means for establishing a call session involving more than two terminals.

14. The apparatus of claim 10 wherein said response message is a redirect message.

15. The apparatus of claim 10 wherein said response message requests a multimedia session.

16. The apparatus of claim 10 wherein said originating terminal is a wireless station.

17. The apparatus of claim 10 wherein said originating terminal is a multimedia device.

18. The apparatus of claim 10 wherein said originating terminal is a mobile computer.
